(19) United States
(12) Patent Application Publication
(10) Pub. No.: US 2008/0236022 A1
(43) Pub. Date: Oct. 2, 2008

(54) Fishing lure with trailer keeper

(76) Inventor: Eric A. Harrell, Pickens, SC (US)

Correspondence Address: J. BENNETT MULLINAX, LLC, P. O. BOX 26029, GREENVILLE, SC, 29616-1029, US

(21) Appl. No.: 11/731,416

(22) Filed: Mar. 30, 2007

(51) Int. Cl. A01K 85/00; A01K 85/02

(52) U.S. Cl. 43/42.39; 43/44.2; 43/44.8; 43/42.42

(57) ABSTRACT

A fishing lure is provided. When arranged as a jig, a head and a hook are attached. A trailer contacts a portion of the hook. A trailer keeper is also included and has a resilient member that engages the trailer. The trailer keeper is configured for limiting movement of the trailer along the hook. The trailer keeper is configured for biasing the trailer to a desired position.

### FIELD OF THE INVENTION

The present invention relates generally to a fishing lure that has a trailer keeper. More particularly, the present application involves a trailer keeper used with a jig that functions to both retain and reposition a jig trailer onto the jig.

### BACKGROUND

The commonly enjoyed sport and leisure activity of fishing involves placing a fishing lure at the end of a line. The fishing lure is designed to move and resemble a prey fish in order to entice a predatory fish into biting. The fishing lure generally includes an object such as a metal oval shaped piece, a plastic scented piece, or a rigid fish-like shaped piece that are used to attract a fish into biting through sight, sound, vibration or smell. Weights to lower the fishing lure below the water's surface and hooks to hook the biting fish are also included in fishing lures.

One type of commonly used fishing lure is a jig. A jig includes a weighted head that is usually made out of lead. A fishing hook is molded or otherwise integrated into the head to form one solid piece. A trailer is passed through the hook and is retained onto a smaller trailer hook of the head. The trailer is a rubber or silicone piece that can be provided in a variety of different shapes, colors and odors. The trailer can be made to resemble a fish, frog, lizard or bug to entice the predatory fish into biting. A rubber or silicone skirt is commonly attached to the head of the jig in order to heighten the allure of the trailer to the fish. Jigs commonly employ a brush guard to protect the hook from snagging on weeds, rocks and other obstacles in the water.

As stated, the trailer is generally made of a soft material that is punctured and slid across the hook. The trailer is then fixed onto the smaller trailer hook of the head in order to be properly retained into position. Unfortunately, the act of fixing the trailer onto the smaller trailer hook of the head can lead to tearing and damaging of the trailer to the point at which it can no longer be properly retained and positioned and must be discarded. Further, a bite from the predatory fish may function to pull the trailer from the smaller trailer hook and thus cause it to tear. The act of casting the fishing lure along with snagging of the fishing lure can also cause the trailer to be torn from the smaller trailer hook of the head. In all of these instances the trailer may be pulled down along the curved portion of the hook and hence be improperly positioned on the jig.

Metal clips have been used in order to prevent the trailer from sliding down the hook once the trailer has been removed from the smaller trailer hook. Although the use of such clips may prevent the trailer from propagating downwards along the hook, the trailer may still become torn through being fixed and subsequently torn from the smaller trailer hook. Additionally, once moved out of its intended, original position the trailer must be subsequently repositioned by the fisherman in order to restore the jig to its normal operating configuration. As such, there remains room for variation and improvement within the art.

### SUMMARY

Various features and advantages of the invention will be set forth in part in the following description, or may be obvious from the description, or may be learned from practice of the invention.

One aspect of one exemplary embodiment includes a jig that has a head and a hook that are attached. A trailer contacts a portion of the hook. A trailer keeper is also included and has a resilient member that engages the trailer. The trailer keeper is configured for limiting movement of the trailer along the hook. The trailer keeper is configured for biasing the trailer to a desired position.

Another aspect of an additional embodiment resides in a jig as immediately discussed in which the resilient member of the trailer keeper has a gripping portion. The gripping portion is located between the trailer and the outside surface of the hook when the resilient member engages the trailer.

One additional aspect of a further embodiment is found in a jig as discussed above in which the head has a skirt collar and a trailer hook. The trailer keeper defines a body retaining aperture. The head is disposed through the body retaining aperture of the trailer keeper so that the trailer keeper is retained on the body between the skirt collar and the trailer hook.

Yet another aspect of another embodiment is found in a jig as discussed above in which the head has a trailer hook. The trailer keeper biases the trailer against the head. The trailer is not hooked onto the trailer hook.

Another aspect of an additional exemplary embodiment resides in a jig as set forth above in which the resilient member of the trailer keeper engages the trailer. The trailer keeper engages the trailer at a location closer to the outside surface of the hook than to the inside surface of the hook.

Still another additional aspect of a further embodiment includes a jig as set forth above in which the resilient member of the trailer keeper defines a resilient member aperture. A portion of the hook and a portion of the trailer are disposed through the resilient member aperture when the resilient member of the trailer keeper engages the trailer.

Another additional aspect of a further embodiment involves a jig as previously discussed in which the hook pierces the trailer. The trailer keeper biases the trailer towards the head.

Also provided in accordance with one aspect of another embodiment is a trailer keeper that has a resilient member configured for engaging a trailer. The trailer keeper urges the trailer to an original starting position relative to a hook when the trailer becomes displaced from the original starting position.

Another aspect exists in a trailer keeper as immediately discussed in which the resilient member defines a resilient member aperture. The resilient member has a gripping portion configured to be grasped by a user in order to place the resilient member into a tensioned position.

A further aspect includes a trailer keeper as immediately mentioned in which the resilient member aperture is generally circular in shape when the resilient member is in a relaxed position. The resilient member aperture is generally rectangular in shape when the resilient member is in the tensioned position.

Another aspect of one embodiment includes a fishing lure that has a hook and a trailer. A trailer keeper engages the trailer and limits movement of the trailer relative to the hook. The trailer keeper urges the trailer to a desired position relative to the hook.

A further aspect of an additional embodiment exists in a fishing lure as immediately set forth that further has a head attached to the hook. The trailer keeper defines a body retaining aperture through which the head is disposed. The resilient member urges the trailer towards the head through engagement with the trailer at a point of engagement closer to the outside surface of the hook than to the inside surface of the hook.

Yet another aspect is found in a fishing lure as previously mentioned that also includes a head attached to the hook. The head has a trailer hook, and the trailer is not attached to the trailer hook.

Another aspect of an additional embodiment includes a fishing lure as set forth above in which the hook pierces the trailer. Also, the desired position to which the trailer is urged by the trailer keeper is at the end of the hook opposite the point of the hook.

These and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a side view of a jig with a trailer keeper in accordance with one exemplary embodiment.

FIG. 2 is a side view of the jig of FIG. 1 in which the trailer has been pulled out of its original position.

FIG. 3 is a top view of the jig of FIG. 1.

FIG. 4 is a front view of a trailer keeper in accordance with one exemplary embodiment.

FIG. 5 is a side view of the trailer keeper of FIG. 4.

FIG. 6 is a side view of a jig with a trailer keeper, skirt and rattle member in accordance with one exemplary embodiment.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a fishing lure 10 that includes a trailer keeper 18 that is used to limit movement of a trailer 16 relative to a hook 14 of the fishing lure 10. The trailer keeper 18 has a resilient member 20 that functions to maintain the trailer 16 in an original position 22. Should the trailer 16 be moved relative to the hook 14 due to snagging of the fishing lure 10 or from a bite by a predatory fish, the resilient member 20 acts to urge the trailer 16 back into its original position 22. Additionally, the trailer 16 need not be hooked onto a trailer hook 32 in order to be maintained in a desired, original position 22 in the fishing lure 10. Instead, the trailer keeper 18 can retain the trailer 16 in an original position 22 without cutting, tearing or puncturing the trailer 16.

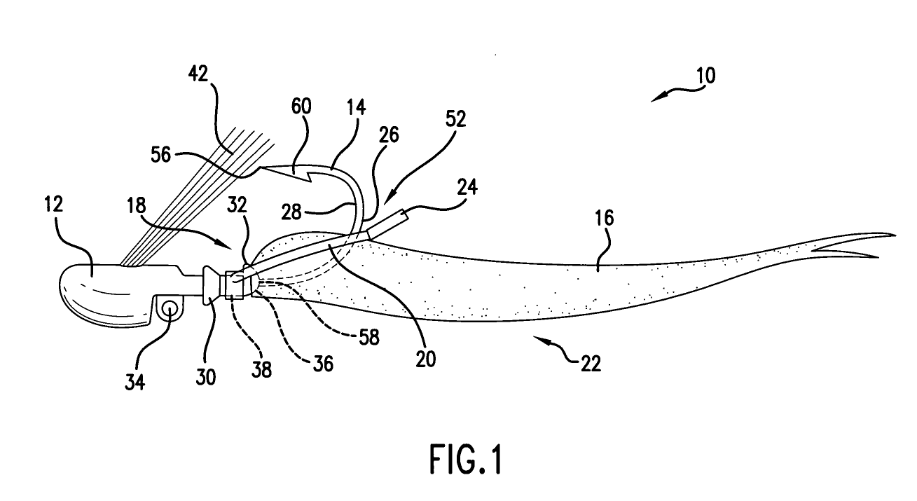

An exemplary embodiment of a fishing lure 10, in this instance a jig 10, is shown in FIG. 1. Here, the jig 10 includes a head 12 which can be made of a heavy material, such as lead, in order to cause the jig 10 to drop below the surface of the water. Head 12 has an eye 34 onto which an end of the fishing line is attached. The head 12 can be configured in a variety of different manners in accordance with various exemplary embodiments. A hook 14 is attached to an end of the head 12. Hook 14 can be a metal piece that is molded into head 14 in order to effect attachment therewith. Various types of attachment methods between head 12 and hook 14 can be used in other embodiments. Additionally, in alternative arrangements, the hook 14 can be made of the same material as head 12. Head 12 also has a skirt collar 30 that is in the shape of a cone. A trailer hook 32 is included and is located at an end 36 of head 12. The jig 10 can be configured in a variety of manners. For example, jig 10 may be provided as that disclosed in U.S. Pat. No. 5,157,859 issued to Wirkus whose contents are incorporated herein in their entirety for all purposes.

The jig 10 includes a trailer 16 made of a soft, flexible rubber or synthetic material. Various types of trailers 16 are known and can be used with the jig 10. One such type of trailer 16 is shown and described in U.S. Pat. NO. 5,524,377 issued to Freeman et al. U.S. Pat. No. 5,524,377 is incorporated by reference herein in its entirety for all purposes. In the illustrated embodiment, trailer 16 is punctured by hook 14 and is slid along the length of hook 14 until being placed into a desired, original position 22 as shown in FIG. 1. Original position 22 of trailer 16 is the position at which the trailer 16 is typically located during normal use of the jig 10 in catching fish. Here, the original position 22 features the trailer 16 located at an end 58 of hook 14 that is opposite the point 56 of hook 14. As such, the trailer 16 is located at the end 36 of head 12 and is against the trailer hook 32.

Jig 10 includes a trailer keeper 18 that is located on the head 12. Trailer keeper 18 has a body retaining aperture 38 through which a portion of the head 12 is disposed in order to effect retention of the trailer keeper 18 onto head 12. The body retaining aperture 38 can be passed over point 56 of hook 14 and moved along the length of hook 14 and eventually passed over the trailer hook 32 and into position. The trailer keeper 18 can be flexible so that the body retaining aperture 38 can expand when passing over larger portions of the head 12 or body 14. Once properly positioned, the body retaining aperture 38 can act to tightly retain the trailer keeper 18 to head 12. However, it is to be understood that other means of attachment to head 12 and/or hook 14 are possible in accordance with other exemplary embodiments.

As stated, the trailer 16 may be pierced by the hook 14 and slid along its length to an original position 22 as shown in FIG. 1. It is to be understood, however, that other embodiments are possible in which it is not necessary to puncture the trailer 16 with hook 14. For example, the trailer 16 may include an eye or some other feature through which the hook 14 may be disposed in order to cause the trailer 16 to be retained. Alternatively, the trailer 16 need not be attached to or contact hook 14 in other exemplary embodiments. With respect to the arrangement in FIG. 1, once trailer 16 is properly positioned, the fisherman can grasp the trailer keeper 18 and move it into the illustrated position. In this regard, trailer keeper 18 has a resilient member 20 that is capable of being stretched from an original configuration into a stretched configuration. The resilient member 20 can be made out of rubber, silicone or a synthetic material in accordance with various exemplary embodiments. The resilient member 20 defines a resilient member aperture 40. A gripping portion 24 is also included to aid the fisherman in grasping and repositioning the trailer keeper 18. The fisherman can grasp the gripping portion 24 and stretch the resilient member 20 until the point 56 of hook 14 is located inside of the resilient member aperture 40. At this point, the fisherman may slide the gripping portion 24 along the outside surface 26 of the hook 14 until the gripping portion 24 and resilient member 20 are moved into the orientation shown in FIG. 1.

The trailer keeper 18 is stretched into a tensioned position 52 in FIG. 1 in which it engages the trailer 16. The resilient member 20 is thus stretched from an original position and consequently acts to bias the trailer 16. As shown, the gripping portion 24 is located between the trailer 16 and the outer surface 26 of the hook 14. The resilient member 20 engages the trailer 16 at a location that is closer to the outside surface 26 of hook 14 than to the inside surface 28 of hook 14. However, it is to be understood that other arrangements are possible in which the resilient member 20 urges trailer 16 at a location that is closer to the inside surface 28 than to outside surface 26. The resilient member 20 can be arranged so that it contacts the outside surface 26 of the hook 14 and does not contact the inside surface 28. Again, other arrangements are possible in which the resilient member 20 contacts the inside surface 28 in addition to or alternatively to contacting the outside surface 26.

Trailer keeper 18 urges the trailer 16 towards the head 12. Trailer keeper 18 thus acts to hold the trailer 16 into the original position 22 shown in FIG. 1. As such, it is not necessary for the trailer 16 to be hooked onto the trailer hook 32 in order to be maintained at a desired, original position 22. Removal of the need to hook the trailer 16 onto trailer hook 32 may be advantageous in that the trailer 16 will not be damaged through being punctured or torn by trailer hook 32 and its useful life will consequently be extended. Further, the trailer keeper 18 may act to provide a more secure retention of trailer 16 to head 12 than is the case when the trailer hook 32 is used for this purpose. Although described as eliminating the need to pierce the trailer 16 with trailer hook 32, it is to be understood that the trailer 16 may be hooked onto trailer hook 32 in accordance with other exemplary embodiments. For example, the trailer 16 may be punctured by hook 14 and hooked onto trailer hook 32 while at the same time trailer keeper 18 is positioned onto trailer 16 in order to further retain the trailer 16 to head 12.

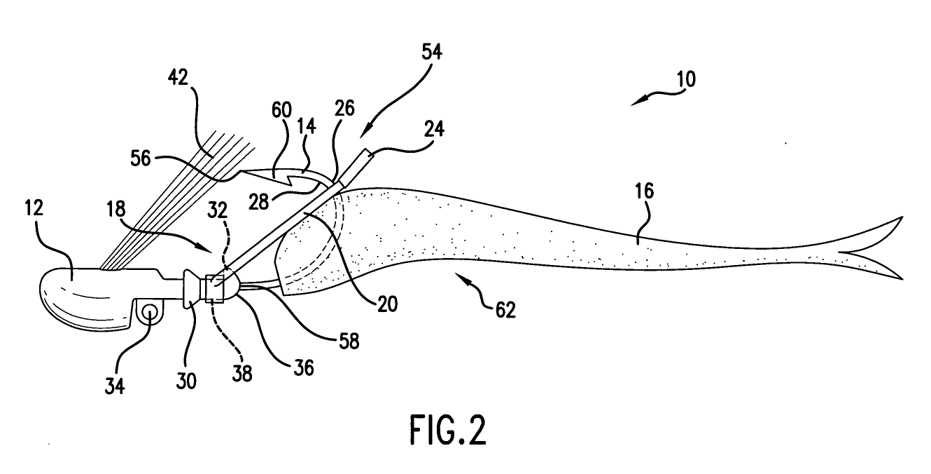

FIG. 2 shows the jig 10 of FIG. 1 in which the trailer 16 has been moved into a displaced position 62. It is sometimes the case that the trailer 16 will be moved out of its original position 22 when struck by a fish. In these instances, the fish may bite and pull on the trailer 16 without catching hook 12. Trailer 16 will be moved along the length of hook 12 towards point 56. As the trailer 16 is now out of its proper position, the fisherman must remove the jig 10 from the water and manually reposition the trailer 16 back into its original position 22. Such an exercise is time consuming and requires the fisherman be careful when removing the jig 10 from the water to avoid injury through contact with hook 14. Hook 14 is commonly constructed with a barb 60 in order to assist in hooking the biting fish during a strike. Movement of trailer 16 out of its original position 22, and along the length of hook 14, increases the chances of contact with barb 60. As the trailer 16 is generally made of a soft, pliable material it will become torn and damaged through contact with barb 60. As such, the useful life of trailer 16 may be reduced when the trailer 16 is moved out of its original position 22. Although described as being removed from its original position 22 through a fish strike, it is to be understood that other circumstances exist in which the trailer 16 can be moved into the displaced position 62 as shown, for example, in FIG. 2. For instance, casting forces or snags can cause the trailer 16 to be displaced with respect to the head 12 and hook 14.

Movement of the trailer 16 into the displaced position 62 causes the trailer keeper 18 to be further stretched into the tensioned position 54. The resilient member 18 is thus stretched and acts to pull the trailer 16 back into the original position 22 shown in FIG. 1. The trailer 16 may be slid along the length of hook 14 through urging by the resilient member 18 so that the trailer 16 is returned into the original position 22 after the fish strike or snag. The jig 10 with trailer 16 therefore does not have to be worked on by the fisherman to be properly oriented but can instead be self-corrected by the trailer keeper 18. Although described as having sufficient resilient force to pull the trailer 16 back into the original position 22, it is to be understood that other embodiments exist in which the trailer keeper 18 is not resilient enough to pull the trailer 16 from the displaced position 62 back into the original position 22. In these embodiments, the trailer keeper 18 may be resilient enough to at least partially pull the trailer 16 towards the original position 22. Alternatively, the trailer keeper 18 may not be resilient enough to pull the trailer 16 any distance from the displaced position 62 but may only function to further limit movement of the trailer 16 from the original position 22.

As stated, the trailer keeper 18 is pulled from an original, relaxed position and placed into the tensioned position 52 shown in FIG. 1. However, in other embodiments, the trailer keeper 18 need not be placed into a tensioned position 52 when oriented as shown in FIG. 1. In these instances, the position of the trailer keeper 18 as shown in FIG. 1 is the relaxed position of the trailer keeper 18. In such a relaxed position, the trailer keeper 18 still acts to hold the trailer 16 at an original position 22. Upon moving the trailer 16 to the displaced position 62 shown in FIG. 2, the trailer keeper 18 will then become tensioned and acts to pull the trailer 16 back into its original position 22. By making the position in FIG. 1 tensioned the trailer keeper 18 functions to hold the trailer 16 tightly against the end 36 of head 12 which may ensure a more consistent and stronger positioning of the trailer 16 on jig 10.

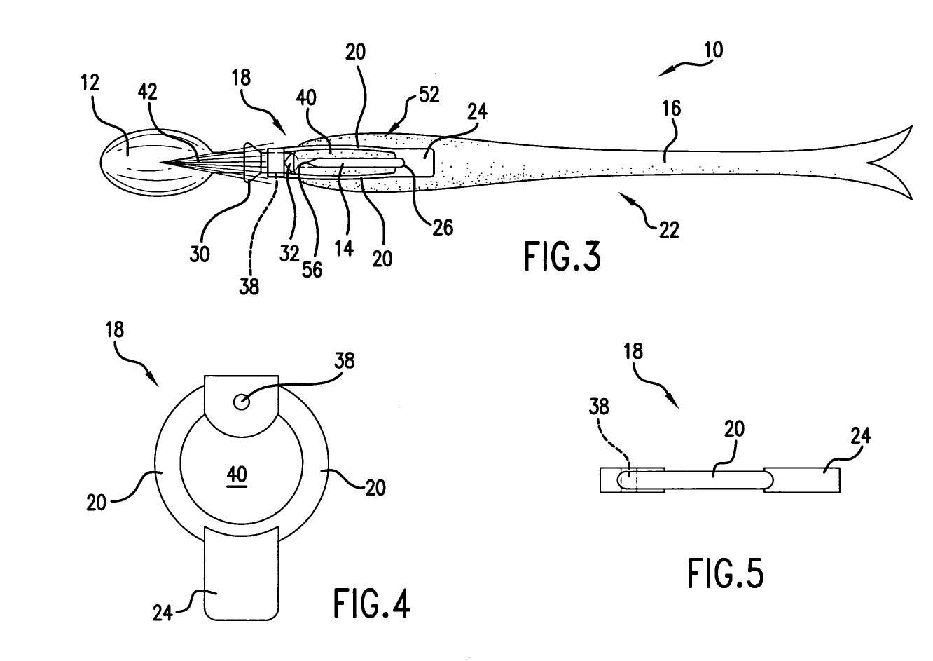

A top view of the jig 10 of FIG. 1 is shown in FIG. 3. It may be seen that the resilient member 20 is stretched into the tensioned position 52 when holding the trailer 16 so that the resilient member aperture 40 assumes a generally rectangular shape. A portion of the hook 14 and part of the trailer 16 are disposed through the resilient member aperture 40. The resilient member 20 engages the trailer 16 at multiple locations. However, the point of engagement at which the resilient member 20 primarily acts to bias the trailer 16 occurs proximate to gripping portion 24 and hence generally opposite from the body retaining aperture 38. The point of primary biasing is located generally at the top of the trailer 16 at a position along the outside surface 26 of the hook 14. Engagement of the resilient member 20 with the trailer 16 may occur along the sides of the trailer 16 as shown in FIG. 3. This engagement may also cause the trailer 16 to be biased towards the original position 22 in some circumstances.

The trailer keeper 18 is retained on the head 12 at a location between the skirt collar 30 and the trailer hook 32. In some instances, the trailer keeper 18 may be arranged so that the body retaining aperture 38 is on the trailer hook 32 so that the trailer hook 32 acts to hold or hook the trailer keeper 18 to the head 12. The trailer 16 is urged against the outside of the trailer hook 32 without actually being hooked thereon.

Front and side views of the trailer keeper 18 in the relaxed, untensioned position are shown in FIGS. 4 and 5. The resilient member 20 forms a resilient member aperture 40 that is generally circular in shape when the resilient member 20 is in the unbiased position. It is to be understood, however, that the resilient member aperture 40 may be variously shaped in the unbiased position in accordance with other exemplary embodiments. A portion of the resilient member has a circular cross-section. The trailer keeper 18 can be a single integral piece or may be separate components attached to one another. Further, although shown as having a resilient member aperture 40 it is to be understood that this feature is not present in accordance with other exemplary embodiments. For example, a smaller aperture may be located in gripping portion 24 and may have the hook 14 disposed therethrough. The resilient member 20 can be a single band that functions to pull the gripping portion and hence the trailer 16 towards the head 12.

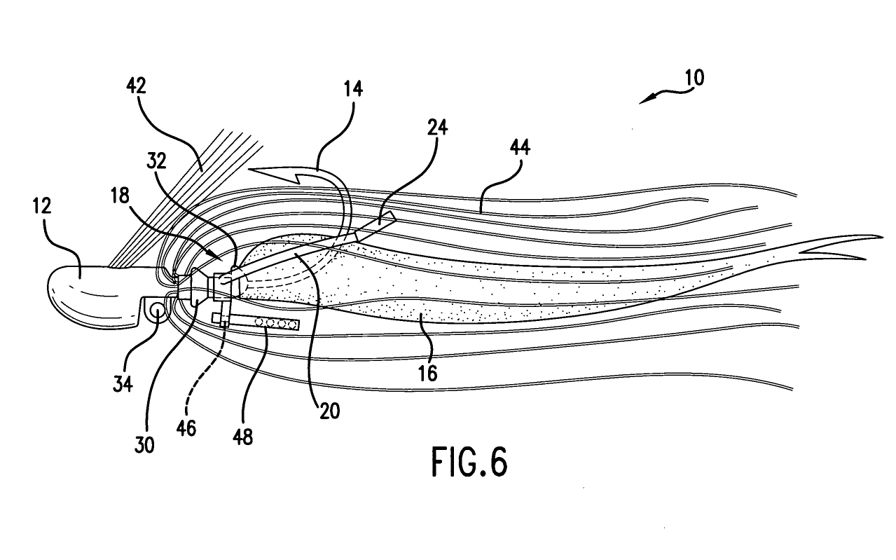

An additional exemplary embodiment of the jig 10 is shown in FIG. 6. Here, the jig 10 includes a brush guard 42 that extends from the head 12. Brush guard 42 is provided to help prevent the hook 14 from snagging on weeds, sticks, rocks or other obstacles during use of the jig 10. Also included in the exemplary embodiment of FIG. 6 is a skirt 44. Skirt 44 can be made of a rubber or synthetic material and may be provided in a variety of shapes, sizes and colors. Skirt 44 can be included in order to attract fish to the jig 10. As such, the trailer 16 and skirt 44 are typically the primarily means of enticing fish to bite jig 10. The skirt 44 can be attached to the skirt collar 30 of the head 12. Another element that may be included in certain exemplary embodiments of jig 10 is a rattle member 48. The rattle member 48 may include one or more metal balls that are housed in a plastic cylinder. The metal balls can move within the plastic cylinder and make noise upon striking one another. Noise made by the rattle member 48 may entice fish into biting the jig 10. The trailer keeper 18 can define a rattle aperture 46 into which a portion of the rattle member 48 may be disposed in order to effect attachment of the rattle member 48 to the jig 10. The rattle member 48 disclosed is but one exemplary embodiment and it is to be understood that other configurations are possible in accordance with additional exemplary embodiments. The additional elements disclosed in FIG. 6 may or may not be present in accordance with various exemplary embodiments of the jig 10.

Although shown and described as a jig 10, it is to be understood that the fishing lure 10 need not be a jig in accordance with other exemplary embodiments. In other exemplary embodiments the fishing lure 10 may be a spinner lure or a spoon lure. Alternatively, the fishing lure 10 may include a hook 14 and trailer 16 with a trailer keeper 18 provided to maintain the trailer 16 at a desired position with respect to hook 14. One or more weighted sinkers that are not attached to the hook 14 can be used to cause the fishing lure 10 to move below the surface of the water.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A jig, comprising:
a head;
a hook attached to said head;
a trailer that contacts a portion of said hook; and
a trailer keeper having a resilient member that engages said trailer, wherein said trailer keeper is configured for limiting movement of said trailer along said hook, and wherein said trailer keeper is configured for biasing said trailer to a desired position.

2. The jig as set forth in claim 1, wherein said resilient member of said trailer keeper has a gripping portion, and wherein said gripping portion is located between said trailer and the outside surface of said hook when said resilient member engages said trailer.

3. The jig as set forth in claim 1, wherein said head has a skirt collar and a trailer hook, and wherein said trailer keeper defines a body retaining aperture, wherein said head is disposed through said body retaining aperture of said trailer keeper such that said trailer keeper is retained on said body between said skirt collar and said trailer hook.

4. The jig as set forth in claim 1, wherein said head has a trailer hook, and wherein said trailer keeper biases said trailer against said head, and wherein said trailer is not hooked onto said trailer hook.

5. The jig as set forth in claim 1, wherein said resilient member of said trailer keeper engages said trailer at a location closer to the outside surface of said hook than to the inside surface of said hook.

6. The jig as set forth in claim 1, wherein said resilient member of said trailer keeper defines a resilient member aperture, wherein a portion of said hook and a portion of said trailer are disposed through said resilient member aperture when said resilient member of said trailer keeper engages said trailer.

7. The jig as set forth in claim 1, further comprising:
a brush guard retained by said head and configured for preventing said hook from snagging; and
a skirt retained by said head.

8. The jig as set forth in claim 1, wherein said trailer keeper defines a rattle aperture, and further comprising a rattle member disposed through said rattle aperture so as to be retained on said trailer keeper, wherein said rattle member is configured for generating noise when moved.

9. The jig as set forth in claim 1, wherein at least a portion of said head is made of lead, and wherein said hook is molded into said head in order to effect attachment between said hook and said head, and wherein said hook does not move relative to said head, and wherein said trailer keeper is made of rubber.

10. The jig as set forth in claim 1, wherein said hook pierces said trailer, and wherein said trailer keeper biases said trailer towards said head.

11. A trailer keeper, comprising:
a resilient member configured for engaging a trailer and for urging the trailer to an original starting position relative to a hook when the trailer becomes displaced from the original starting position.

12. The trailer keeper as set forth in claim 11, wherein said resilient member defines a resilient member aperture, and wherein said resilient member has a gripping portion configured to be grasped by a user in order to place said resilient member into a tensioned position.

13. The trailer keeper as set forth in claim 12, wherein said resilient member aperture is generally circular in shape when said resilient member is in a relaxed position, and wherein said resilient member aperture is generally rectangular in shape when said resilient member is in the tensioned position.

14. The trailer keeper as set forth in claim 11, wherein said resilient member defines a body retaining aperture configured for having a head of a jig disposed therethrough in order to retain said resilient member onto the head of the jig.

15. The trailer keeper as set forth in claim 11, wherein said resilient member is made of rubber.

16. A fishing lure, comprising:
a hook;
a trailer; and
a trailer keeper that engages said trailer and limits movement of said trailer relative to said hook, wherein said trailer keeper urges said trailer to a desired position relative to said hook.

17. The fishing lure as set forth in claim 16, further comprising a head attached to said hook, wherein said trailer keeper defines a body retaining aperture through which said head is disposed, and wherein said resilient member urges said trailer towards said head through engagement with said trailer at a point of engagement closer to the outside surface of said hook than to the inside surface of said hook.

18. The fishing lure as set forth in claim 16, further comprising a head attached to said hook, wherein said head has a trailer hook, and wherein said trailer is not attached to said trailer hook.

19. The fishing lure as set forth in claim 16, wherein said hook pierces said trailer, and wherein the desired position to which said trailer is urged by said trailer keeper is at the end of said hook opposite the point of said hook.

20. The fishing lure as set forth in claim 16, wherein said trailer keeper is made of rubber, and wherein said trailer keeper has a gripping portion that is located between said trailer and the outside surface of said hook when said trailer keeper engages said trailer.
